(19) United States
(12) Patent Application Publication
(10) Pub. No.: US 2012/0173474 A1
(43) Pub. Date: Jul. 5, 2012

(54) METHOD AND SYSTEM FOR PREDICTING TRAVEL TIME BACKGROUND

(76) Inventors: Avhishek Chatterjee, Bangalore (IN); Samik Datta, Bangalore (IN); Supratim Deb, Bangalore (IN); Vikram Srinivasan, Bangalore (IN)

(21) Appl. No.: 13/390,714

(22) PCT Filed: Sep. 24, 2009
(86) PCT No.: PCT/IN2009/000523

§ 371 Date: Feb. 16, 2012

(51) Int. Cl. G06N 5/02

(52) U.S. Cl. 706/52

(57) ABSTRACT

A method and system is provided for predicting at a current time “t”, a time that may be taken to travel between plurality of locations, at a future time-point “t+τ”. The method includes determining deterministic component “μ_{t+τ}” and predicting random fluctuation component “y¹_{t+τ}”, of the time that may be taken to travel between the plurality of locations at the future time-point “t+τ”. The deterministic component “μ_{t+τ}” and the random fluctuation component “y¹_{t+τ}” are added to predict the time that may be taken to travel between the plurality of locations, at the future time-point “t+τ”.

### BACKGROUND

1. Technical Field

This invention relates to techniques of road traffic management and, more particularly but not exclusively, to predicting time required to travel at a future time-point.

2. Description of the Related Art

Traffic management being one of key areas which have an impact on the economy of the country, efficient traffic management is desirable. One aspect of traffic management deals with creating adequate transportation infrastructure for ensuring reasonable transit duration. While, another aspect of traffic management deals with providing services which enable users of the transportation infrastructure to plan their commute accordingly. One such service relates to predicting travel time between multiple locations at a future time-point.

Attempts have been made to predict time that may be required to travel between multiple locations at a future time-point. In one of the existing methods, Support Vector Regression (SVR), which is an analytical technique for forecasting a time series, has been applied to forecast travel times. The method of SVR, which is a standard machine learning model, and which has been applied previously for predicting power consumptions, financial markets etc., has been applied to forecast travel times. However, this method has been found to under-perform in predicting travel times in city-road scenario, barring its usefulness. It has been further observed that this method is not good at handling rare but very high congestion.

Further, methods based on Association Rule Mining based technique have been applied for forecasting traffic volumes in a road-network. Association Rule Mining, which is a known practice in data mining is used to determine which roads are most influential on traffic volumes present at that time in all other roads. Once the most influential roads are identified, traffic volumes on these most influential roads are determined, and the same is used to forecast traffic volumes on the remaining roads. However, it is hard to translate a traffic volume prediction into a travel time prediction, especially on a stretch of road comprising of multiple segments with widely varying traffic volumes.

Additionally, another technique based on Wavelet is used to predict traffic volumes at a road junction (intersection). Initially, traffic volume time series is broken down into a trend series and a hierarchy of variation series using Wavelet Transformation (a standard tool in signal processing). Then the trend series is predicted with the help of a Neural Network (another standard tool in Machine Learning). The remaining hierarchy of variation series is predicted using Markov Models (a standard modeling technique). All these predictions are later combined to forecast the overall traffic volume time series. However, it may be noted that this method has been used to predict traffic volumes at a junction, and it is hard to translate traffic volume forecast into a forecast of travel time between two points. Further, this approach has been observed to grossly underestimate characteristics of travel time evolution in a city road network.

### SUMMARY

An embodiment herein provides a method for predicting at a current time “t”, a time that may be taken to travel between plurality of locations, at a future time-point “t+τ”. The method includes determining deterministic component “μ t+τ” of the time that may be taken to travel between the plurality of locations at the future time-point “t+τ”, and predicting random fluctuation component “μt+τ” of the time that may be taken to travel between the plurality of locations at the future time-point “t+τ”. Subsequently, the deterministic component “μt+τ” of the time that may be taken to travel between the plurality of locations is added to the predicted random fluctuation component “y1t+τ” of the time that may be taken to travel between the plurality of locations, to predict the time that may be taken to travel between the plurality of locations, at a future time-point “t+τ”. To predict the random fluctuation component “y1 t+τ”, a random fluctuation component “yt” of time taken to travel between the plurality of location at the current time “t” is determined. Further, a quantization state in which the random fluctuation component yt lies in is identified. Subsequently, linear mean square error parameters are computed based on past travel times chosen from historical data based on the quantization state and period “Tp” of wide sense cyclostationarity of time taken to travel between the plurality of locations previously. Further, the random fluctuation component “y1 t+τ” of the time that may be taken to travel between the plurality of locations is computed using the parameters of linear mean square error.

Another embodiment provides a system for predicting at a current time “t”, a time that may be taken to travel between plurality of locations, at a future time-point “t+τ”. The system includes, a data repository and a processor. The data repository is configured to at least store historical data relating to time taken to travel between the plurality of locations. The processor is configured to, determine deterministic component “μ t+τ” of the time that may be taken to travel between the plurality of locations at the future time-point “t+τ”, predict random fluctuation component “y1 t+τ” of the time that may be taken to travel between the plurality of locations at the future time-point “t+τ”, and add the deterministic component “μt+τ” of the time that may be taken to travel between the plurality of locations with the predicted random fluctuation component “y1t+τ” of the time that may be taken to travel between the plurality of locations. For predicting the random fluctuation component “y1 t+τ”, the processor is configured to determine a random fluctuation component “yt” of time taken to travel between the plurality of location at the current time and subsequently determine a quantization state in which the random fluctuation component yt lies. The processor is further configured to compute linear mean square error parameters based on past travel times chosen from historical data based on the quantization state and period “Tp” of wide sense cyclostationarity of time taken to travel between the plurality of locations previously, and compute random fluctuation component “y1 t+τ” of the time that may be taken to travel between the plurality of locations using the parameters of linear mean square error.

These and other aspects of the embodiments herein will be better appreciated and understood when considered in conjunction with the following description and the accompanying drawings.

### BRIEF DESCRIPTION OF THE FIGURES

Some embodiments of apparatus and/or methods in accordance with embodiments of the present invention are now described, by way of example only, and with reference to the accompanying drawings, in which:

FIG. 1 is a flow chart depicting a method of predicting time that may be required to travel between multiple locations, in accordance with an embodiment;

FIG. 2 is a flow chart depicting a method of determining a deterministic component of time that may be required to travel between multiple locations, in accordance with an embodiment:

FIG. 3 is graph illustrating a power-spectrum plot, across various frequency components of a Fourier transform of average travel time, in accordance with an embodiment;

FIG. 4 is a graph illustrating power-spectrum plot, across various frequency components of Fourier transform of autocorrelation, in accordance with an embodiment; and

FIG. 5 illustrates a block diagram of a system for predicting time that may be required to travel between multiple locations, in accordance with an embodiment.

### DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

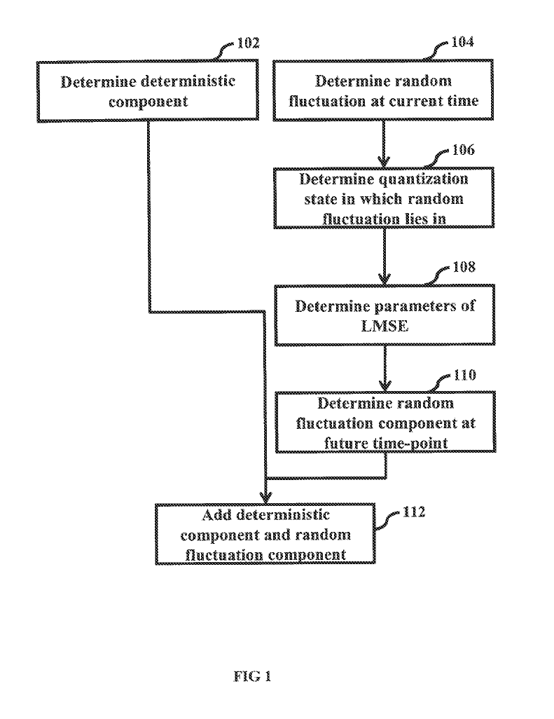

The embodiments herein provide a method and system for predicting at a current time, a time that may be taken to travel between plurality of locations, at a future time-point. Referring now to the drawings, and more particularly to FIGS. 1 through 5, where similar reference characters denote corresponding features consistently throughout the figures, there are shown embodiments.

To enable prediction, historical data comprising time taken to travel between the multiple locations previously is stored. These travel times which are stored may be referred to as time series. It has been observed that these travel times exhibit certain pattern, and can be considered to be a stochastic process. A stochastic process is said to be cyclo-stationary, if distribution governing the process is periodic with a period say T. However, cyclostationarity in this strict sense is hard to confirm for time series related to travel times, hence, the time series may be considered to be “wide-sense cyclostationary”, which is a weaker notion as compared to cyclostationary

The time series is used to predict at a current time which can be referred to as “t”, the time that may be required to travel between multiple locations at a future time-point. The future time-point may be referred to as “t+τ”. A method for predicting includes adding a deterministic component “μ_{t+τ}” of the time that may be required to travel between multiple locations at the future time-point “t+τ”, with a random fluctuation component “y¹_{t+τ}” of the time that may be required to travel between multiple locations at the future time-point. The deterministic component of the time that may be required to travel between multiple locations at the future time-point “t+τ” can be represented by “μ_{t+τ}”, and the random fluctuation component of the time that may be required to travel between multiple locations at the future time-point “t+τ” can be represented by “y¹_{t+τ}”. Therefore, the predicted time required to travel between the multiple locations at the future time-point “t+τ” is equal to μ_{t+τ}+y¹_{t+τ}.

FIG. 1 is a flow chart depicting a method of predicting time that may be required to travel between multiple locations, in accordance with an embodiment. The method includes determining deterministic component “μ_{t+τ}” of the time that may be taken to travel between the plurality of locations at the future time-point “t+τ”, at step 102. Additionally, a random fluctuation component “y¹_{t+τ}” of the time that may be taken to travel between the plurality of locations at the future time-point “t+τ”, is predicted. To predict the random fluctuation component “y¹_{t+τ}”, a random fluctuation component “yₜ” of time taken to travel between the plurality of location at the current time “t” is determined, at step 104. Further, at step 106 a quantization state in which the random fluctuation component yₜ lies in is identified. Subsequently, at step 108, linear mean square error parameters are computed based on past travel times chosen from historical data based on the quantization state and period “Tₚ” of wide sense cyclostationarity of time taken to travel between the plurality of locations previously. Further, at step 110 the random fluctuation component “y¹_{t+τ}” of the time that may be taken to travel between the plurality of locations is computed using the parameters of linear mean square error. Subsequently, at step 112, the deterministic component “μ_{t+τ}” of the time that may be taken to travel between the plurality of locations is added to the predicted random fluctuation component “y¹_{t+τ}” of the time that may be taken to travel between the plurality of locations, to predict the time that may be taken to travel between the plurality of locations, at a future time-point “t+τ”

### Determining Deterministic Component of Travel Time

As mentioned above, to be able to predict time that may be required to travel at a future time-point, it is essential to know the deterministic component of the travel time at the future time point.

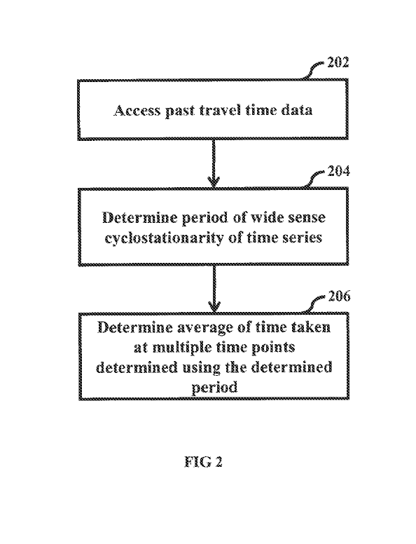

FIG. 2 is a flow chart depicting a method of determining the deterministic component of time that may be required to travel between multiple locations, in accordance with an embodiment. The deterministic component is determined using historical data by accessing past travel times which is a part of historical data, at step 202. The historical data is a record of the actual time taken to travel between the multiple locations at various time points. The actual time taken to travel between the multiple locations may be determined using solutions such as, systems and methods using, In-road Sensors, vehicles with GPS-based devices as probes, cellular triangulation based solutions, near field communication devices in vehicles, among others. The actual time taken to travel between the multiple locations at various time points is stored and continuously updated. The historical data is used to determine period at which travel times exhibit wide sense cyclostationarity, at step 204.

The travel times which can also be referred to as time series is a stochastic process. A stochastic process is said to be cyclostationary if its distribution is periodic with period “Tₚ”. For example, suppose the distribution of the travel time on any day at 10 AM is identical to the distribution of travel time at 10 AM on any other day, then the process is said to be cyclostationary with period 24 hours. However, cyclostationarity in this strict sense is hard to confirm. Hence, the time series can be said to exhibit wide-sense cyclostationarity, which is a weaker notion as compared to cyclostationarity. To determine the period of the wide-sense cyclostationarity, power spectrum of Fourier transform of means and auto-correlation of the time series are examined. From the examination, the period is typically considered as a lowest frequency component at which power values peak.

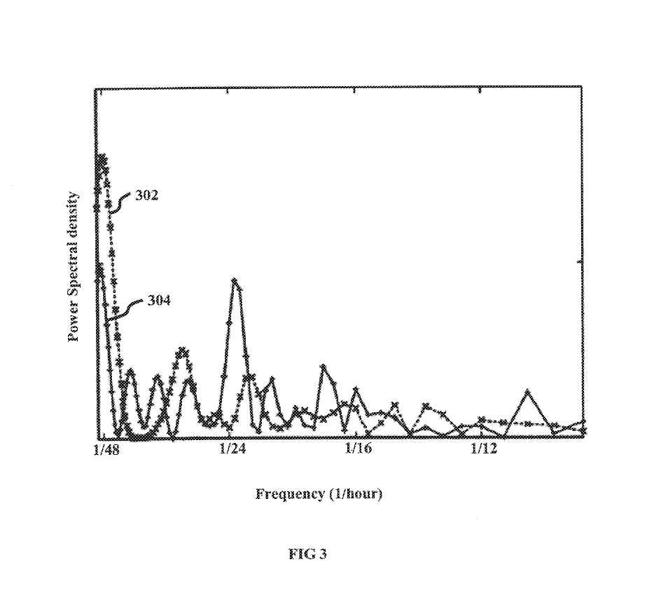

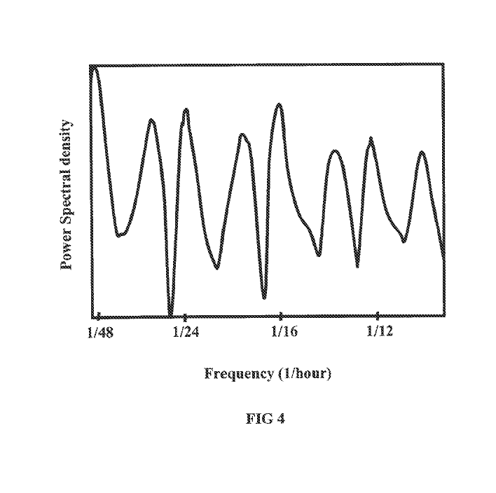

FIG. 3 is graph illustrating a power-spectrum plot, across various frequency components of the Fourier transform of average travel time, in accordance with an embodiment. The graph illustrates power spectrum plot for two consecutive links that constitute the road between the multiple locations. Line 302 is the power spectrum plot of first link and line 304 is the power spectrum plot of second link. Further, FIG. 4 is a graph illustrating power-spectrum plot, across various frequency components of the Fourier transform of autocorrelation, in accordance with an embodiment. From both the graphs, it can be observed that both the average travel time and the autocorrelation function show distinct peaks at a frequency of 1/48, i.e., the travel times are wide sense cyclostationary with a period of 48 hours. In an embodiment, the period is the lowest frequency at which power values of the Fourier transform peak.

The period of wide sense cyclostationarity of the time series related to commute between the multiple locations is used to determine the deterministic component of the time that may be taken to travel between the multiple locations, at step 206.

In an embodiment, the deterministic component of the time that may be taken to travel between the multiple locations is determined using the below equation:

$${μ}_{t + τ} = \frac{1}{N} {\sum }_{i = 1}^{N} {X}_{t + τ - iTp}$$

In the above equation “N” depends on the number of relevant samples time points considered from the historical data, and X is the actual time taken to travel between the multiple locations at the time points being considered.

### Determining Random Fluctuation Component of Travel Time

As mentioned earlier, to be able to predict the time that may be required to travel between the multiple locations at the future time point, a random fluctuation component of travel time at the future time point has to be determined in addition to determining the deterministic component of the travel time at the future time point.

The random fluctuation component of travel time at the future time point can be referred to as y_{t+τ}, and a predicted, value of the random fluctuation component of travel time at the future time point can be referred to as y¹_{t+τ}. Further, the random fluctuation component of travel time at the current time or at the time of prediction can be referred to as yₜ. In an embodiment, y_{t+τ} is predicted based on the fact, that correlation structure between yₜ and y_{t+τ} is periodic with periodicity Tₚ. FIG. 4 is a graph illustrating Fourier transform of auto-covariance process of yₖ. In the figure, it can be seen that periodicity of the auto-covariance process of yₖ is 48 hours. In an embodiment, to enable determination of y_{t+τ}, a histogram of values of yₛ, where s≦t is prepared using the past travel times in the historical data. Further, in an embodiment, entire range of yₛ is divided in “n” quantization states, [q₁, q₂], [q₂, q₃], [q₃, q₄] and so on. Later, the quantization state in which yₜ lies in is identified. The quantization state in which yₜ lies in can be referred to as [qₖ, qₖ₊₁], where qₖ is chosen as 100(k−1)/n^{th} percentile value in the histogram. After determining the above, y_{t+τ} is predicted using the below equation:

Y¹_{t+τ}=A_{t,τ}yₜ+B_{t,τ}

Where A_{t,τ} and B_{t,τ} are obtained by solving the below equations:

$${A}_{t , τ} ( \frac{1}{N} {\sum }_{s ∈ P} {y}_{s} ) + {B}_{t , τ} = \frac{1}{N} {\sum }_{s ∈ P} {y}_{s + τ}$$

$${A}_{t , τ} \frac{1}{( N )} {\sum }_{s ∈ P} {y}_{s}^{2} + {B}_{t , τ} ( \frac{1}{N} {\sum }_{s ∈ P} {y}_{s} ) = \frac{1}{N} {\sum }_{s ∈ P} y {}_{s}^{}{y}{}_{s + τ}^{} ,$$

Where all the summations are carried over the set

P={s:s=t−iTₚ for some i, and qₖ<ys≦qₖ₊₁}

and N=|P|

The above equations ensures that instead of performing LMSE on the entire range of yₛ to compute parameters of LMSE, parameters of LMSE are computed based on the quantization state yₛ lies in.

After determining the random fluctuation component at the future time-point, the time that may be required to travel between the multiple locations at the future time-point is predicted as μ_{t+τ}+Y¹_{t+τ}

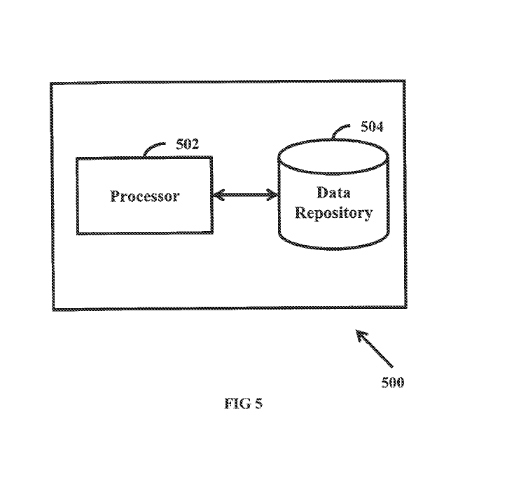

An embodiment provides a system for predicting at a current time “t”, a time that may be taken to travel between plurality of locations, at a future time-point “t+τ”. FIG. 5 illustrates a block diagram of a system 500 for predicting time that may be required to travel between multiple locations, in accordance with an embodiment. The system includes, a data repository 502 and a processor 504. The data repository 502 is configured to at least store historical data relating to time taken to travel between the plurality of locations. The processor 504 is configured to, determine deterministic component “μ_{t+τ}” of the time that may be taken to travel between the plurality of locations at the future time-point “t+τ”, predict random fluctuation component “y1_{t+τ}” of the time that may be taken to travel between the plurality of locations at the future time-point “t+τ”, and add the deterministic component “μ_{t+τ}” of the time that may be taken to travel between the plurality of locations with the predicted random, fluctuation component “y1_{t+τ}” of the time that may be taken to travel between the plurality of locations. For predicting the random fluctuation component “y¹_{t+τ}”, the processor 504 is configured to determine a random fluctuation component “yt” of time taken to travel between the plurality of location at the current time and subsequently determine a quantization state in which the random fluctuation component yt lies. The processor 504 is further configured to compute linear mean square error parameters based on past travel times chosen from historical data based on the quantization state and period “Tp” of wide sense cyclostationarity of time taken to travel between the plurality of locations previously, and compute random fluctuation component “y1 t+τ” of the time that may be taken to travel between the plurality of locations using the parameters of linear mean square error.

A person of skill in the art would readily recognize that steps of various above-described methods can be performed by programmed computers. Herein, some embodiments are also intended to cover program storage devices, e.g., digital data storage media, which are machine or computer readable and encode machine-executable or computer-executable programs of instructions, wherein said instructions perform some or all of the steps of said above-described methods. The program storage devices may be, e.g., digital memories, magnetic storage media such as a magnetic disks and magnetic tapes, hard drives, or optically readable digital data storage media. The embodiments are also intended to cover computers programmed to perform said steps of the above-described methods.

The description and drawings merely illustrate the principles of the invention. It will thus be appreciated that those skilled in the art will be able to devise various arrangements that, although not explicitly described or shown herein, embody the principles of the invention and are included within its spirit and scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

The functions of the various elements shown in the FIG. 4, including any functional blocks labeled as “processor”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should, not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non volatile storage. Other hardware, conventional and/or custom, may also be included. Similarly, any switches shown in the FIGS. are conceptual only. Their function may be carried out through the operation of program logic, through dedicated logic, through the interaction of program control and dedicated logic, or even manually, the particular technique being selectable by the implementer as more specifically understood from the context.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

What is claimed is:

1. A method for predicting at a current time “t”, a time that may be taken to travel between plurality of locations, at a future time-point “t+τ”, thereby enabling users to plan their travel, the method comprising:
determining deterministic component “μ_{t+τ}” of the time that may be taken to travel between the plurality of locations at the future time-point “t+τ”;
predicting random fluctuation component “y¹_{t+τ}” of the time that may be taken to travel between the plurality of locations at the future time-point “t+τ”, comprising:
determining a random fluctuation component “yₜ” of time taken to travel between the plurality of location at the current time;
determining a quantization state in which the random fluctuation component yₜ lies;
computing linear mean square error parameters based on past travel times chosen from historical data based on the quantization state and period “Tₚ” of wide sense cyclostationarity of time taken to travel between the plurality of locations previously;
computing random fluctuation component “y¹_{t+τ}” of the time that may be taken to travel between the plurality of locations using the parameters of linear mean square error; and
adding the deterministic component “μ_{t+τ}” of the time that may be taken to travel between the plurality of locations with the predicted random fluctuation component “y¹_{t+τ}” of the time that may be taken to travel between the plurality of locations.

2. The method according to claim 1, wherein, the deterministic component “μ_{t+τ}” is determined by averaging past travel times at time points corresponding to the future time-point “t+τ”, wherein the time points corresponding to the future time-point “t+τ” are determined using the period “Tₚ”, wherein the deterministic component “μ_{t+τ}” is determined using equation:
$${μ}_{t + τ} = \frac{1}{N} {\sum }_{i = 1}^{N} {X}_{t + τ - iTp} ,$$
wherein “N” is number of relevant time point samples considered from the historical data.

3. The method according to claim 1, wherein, determining the quantization state in which the random fluctuation component yₜ lies, comprises, dividing entire range of random fluctuation components in the past travel times into multiple quantization states.

4. The method according to claim 1, wherein, the random fluctuation component “y¹_{t+τ}” is computed using equation:
Y¹_{t+τ}=A_{t,τ}yₜ+B_{t,τ}

5. The method according to claim 4, wherein, “A_{t, τ}” and “B_{t, τ” are determined using equations:}
$${A}_{t , τ} ( \frac{1}{N} {\sum }_{s ∈ P} {y}_{s} ) + {B}_{t , τ} = \frac{1}{N} {\sum }_{s ∈ P} {y}_{s + τ}$$
$${A}_{t , τ} \frac{1}{( N )} {\sum }_{s ∈ P} {y}_{s}^{2} + {B}_{t , τ} ( \frac{1}{N} {\sum }_{s ∈ P} {y}_{s} ) = \frac{1}{N} {\sum }_{s ∈ P} y {}_{s}^{}{y}{}_{s + τ}^{} ,$$
wherein, all summations are carried over set:
P={s:s=t−iTₚ for some i, and qₖ<ys≦qₖ₊₁}
and N=|P|

wherein, [qₖ, ≦qₖ₊₁] is the quantization state in which yₜ lies.

6. The method according to claim 5, wherein the “qₖ” is chosen as 100(k−1)/n^{th} percentile value in histogram of random fluctuation components “yₛ”, wherein s≦t, and “n” is number of quantization states the entire range of random fluctuation components in the past travel times divided into.

7. The method according to claim 1, wherein the period “Tₚ” of wide sense cyclostationarity of time taken to travel between the plurality of locations previously is derived from a lowest frequency at which power values of Fourier transform of means and auto-correlation of the time taken to travel between the plurality of locations previously, peak.

8. A system for predicting at a current time “t”, a time that may be taken to travel between plurality of locations, at a future time-point “t+τ”, to enable users to plan their travel, the system comprising:
a data repository configured to at least store historical data relating to time taken to travel between the plurality of locations; and
a processor configured to:
determine deterministic component “μ_{t+τ}” of the time that may be taken to travel between the plurality of locations at the future time-point “t+τ”;
predict random fluctuation component “y¹_{t+τ}” of the time that may be taken to travel between the plurality of locations at the future time-point “t+τ”, wherein the prediction comprises:
determining a random fluctuation component “yₜ” of time taken to travel between the plurality of location at the current time;
determining a quantization state in which the random fluctuation component yₜ lies;
computing linear mean square error parameters based on past travel times chosen from historical data based on the quantization state and period “Tₚ” of wide sense cyclostationarity of time taken to travel between the plurality of locations previously;
computing random fluctuation component “y¹_{t+τ}” of the time that may be taken to travel between the plurality of locations using the parameters of linear mean square error; and
add the deterministic component “μ_{t+τ}” of the time that may be taken to travel between the plurality of locations with the predicted random fluctuation component “y¹_{t+τ}” of the time that may be taken to travel between the plurality of locations.

9. The system, according to claim 8, wherein, the processor is configured to determine the deterministic component “μ_{t+τ}” by averaging past travel times at time points corresponding to the future time-point “t+τ”, wherein the time points corresponding to the future time-point “t+τ” are determined using the period “Tₚ”, wherein the deterministic component “μ_{t+τ}” is determined using equation:
$${μ}_{t + τ} = \frac{1}{N} {\sum }_{i = 1}^{N} {X}_{t + τ - iTp} ,$$
wherein “N” is number of relevant time point samples considered, from historical data.

10. The system according to claim 8, wherein, the processor is configured to divide entire range of random fluctuation components in the past travel times into multiple quantization states to determine the quantization state in which the random fluctuation component yₜ lies.

11. The system according to claim 1, wherein, the processor is configured to compute the random fluctuation component “y¹_{t+τ}” using equation:
Y¹_{t+τ}=A_{t,τ}yₜ+B_{t,τ}

12. The system according to claim 11, wherein, the processor is configured to determine “A_{t,τ}” and “B_{t,τ}” using equations:
$${A}_{t , τ} ( \frac{1}{N} {\sum }_{s ∈ P} {y}_{s} ) + {B}_{t , τ} = \frac{1}{N} {\sum }_{s ∈ P} {y}_{s + τ}$$
$${A}_{t , τ} \frac{1}{( N )} {\sum }_{s ∈ P} {y}_{s}^{2} + {B}_{t , τ} ( \frac{1}{N} {\sum }_{s ∈ P} {y}_{s} ) = \frac{1}{N} {\sum }_{s ∈ P} y {}_{s}^{}{y}{}_{s + τ}^{} ,$$
wherein, all summations are carried over set:
P={s:s=t−iTₚ for some i, and qₖ<ys≦qₖ₊₁}
and N=|P|

wherein, [qₖ, ≦qₖ₊₁] is the quantization state in which yₜ lies.

13. The system according to claim 12, wherein the processor is configured to choose “qₖ” as 100(k−1)/n^{th} percentile value in histogram of random fluctuation components “yₛ”, wherein s≦t, and “n” is number of quantization states the entire range of random fluctuation components in the past travel times divided into.

14. The system according to claim 8, wherein processor is configured to derive the period “Tₚ” of wide sense cyclostationarity of time taken to travel between the plurality of locations previously from a lowest frequency at which power values of Fourier transform of means and auto-con-elation of the time taken to travel between the plurality of locations previously, peak.
